(19) United States
(12) Patent Application Publication
(10) Pub. No.: US 2007/0102170 A1
(43) Pub. Date: May 10, 2007

(54) Crimp Hub for Anastomosis Device

(76) Inventor: Larry E. Waldack, Minnetonka, MN (US)

Correspondence Address: AMS RESEARCH CORPORATION, 10700 BREN ROAD WEST, MINNETONKA, MN, 55343, US

(21) Appl. No.: 11/558,251

(22) Filed: Nov. 9, 2006

Related U.S. Application Data
(60) Provisional application No. 60/734,929, filed on Nov. 9, 2005.

(51) Int. Cl. A01B 1/00

(52) U.S. Cl. 172/371

(57) ABSTRACT

The needs described above are in large part addressed by the crimp hub for an anastomosis device, or tissue approximating device, of the present invention. The tissue approximating device generally includes the components of a plurality of tissue engaging tines, an actuator, a tine deflector, and a hub. The tissue engaging tines extends through the deflector and into the hub. To maintain the tines within the hub, the external circumference of the hub is crimped, preferably at least two times, to create a pull strength between the tines and hub of at least 4 lbs. The actuator is preferably an actuator wire and is secured to the external surface of the hub through the same crimping motion that secures the tines. The crimping of the actuator to the hub preferably creates a pull strength between the actuator and the hub of at least 8 lbs.

### CLAIM TO PRIORITY

The present application claims priority to U.S. provisional patent application No. 60/734,929, filed Nov. 9, 2005, and entitled “Crimp Hub for Anastomosis Device.” The identified provisional application is hereby incorporated by reference in its entirety.

### FIELD OF THE INVENTION

The present invention relates to an anastomosis device for connecting urethra and bladder tissues after a radical prostatectomy and, more particularly, to a crimp hub to maintain the tines of the anastomosis device.

### BACKGROUND OF THE INVENTION

An anastomosis device for the connection of tissues, e.g., urethra and bladder tissues after a radical prostatectomy, is described in U.S. patent application Ser. Nos. 10/646,383, 10/919,775, 10/919,545, 11/356,755, 11/356,556, 11/437,960, and 11/437,963. Each of the identified utility patent applications is hereby incorporated by reference.

One embodiment of the anastomosis device described within the noted applications utilizes a tissue approximating structure that has a plurality of tines that can be movably extended from corresponding apertures at the distal end of a catheter body. The tines are used to contact and optionally penetrate into or through the one or more of a tissue of the bladder, bladder neck, urethra, bulbar urethra, urethral stump, or perineal floor, to place opposing severed tissue surface into contact for healing, and preferably also to hold the tissues in contact with each other during the healing period. It is essential that the tines not be able to be separated from the tissue approximating structure, the loosening or separation of a tine could significantly effect the tissue approximating function of the device. As such there is a need to maintain the tines in substantially permanent manner within the device.

### SUMMARY OF THE INVENTION

The needs described above are in large part addressed by the crimp hub for an anastomosis device, or tissue approximating device, of the present invention. The tissue approximating device generally includes the components of a plurality of tissue engaging tines, an actuator, a tine deflector, and a hub. The tissue engaging tines extends through the deflector and into the hub. To maintain the tines within the hub, the external circumference of the hub is crimped, preferably at least two times, to create a pull strength between the tines and hub of at least 4 lbs. The actuator is preferably an actuator wire and is secured to the external surface of the hub through the same crimping motion that secures the tines. The crimping of the actuator to the hub preferably creates a pull strength between the actuator and the hub of at least 8 lbs.

With the tines and actuator secured, the tissue approximating structure can be actuated; a first actuation of the actuator causes the tines to extend forward and outward from the deflector while a second actuation of the actuator draws in tines back towards the deflector.

### DESCRIPTION OF THE DRAWINGS

FIG. 1 is a prior art depiction of a plurality of tines welded to a hub that forms a portion of a tissue approximating structure of an anastomosis device.

FIG. 2 is a perspective view of an uncrimped hub of the present invention.

FIG. 3 is a side view of the hub having been crimped about a plurality of tines.

FIG. 4 is a sectional view taken along line A-A of FIG. 3.

### DESCRIPTION OF THE PREFERRED EMBODIMENTS

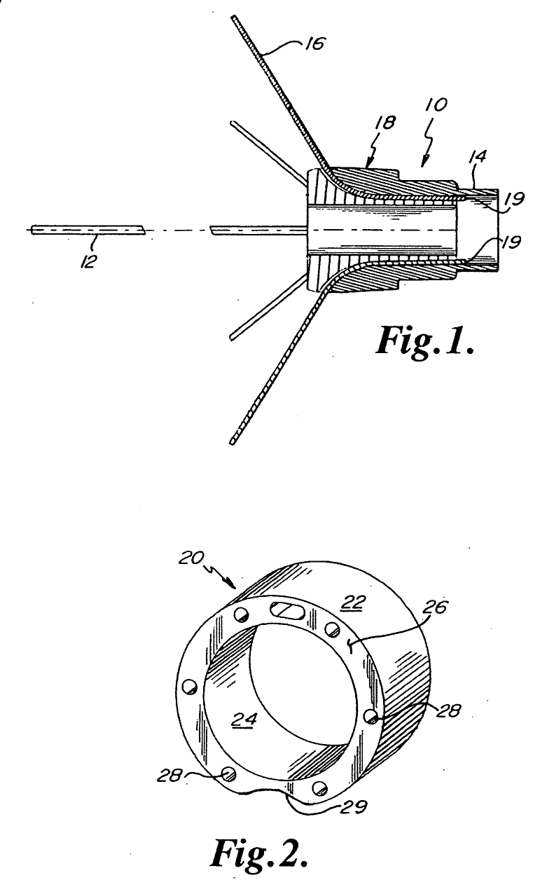

FIG. 1 shows a prior art configuration of a portion of the tissue approximating structure 10 wherein an actuating wire 12 extends to a hub 14 from which a plurality of tines 16 extend. The tines 16 extend further into a deflector 18 that enables the tines 16 to be further extended angularly outward therefrom and withdrawn back in. In this configuration the tines 16 are actually welded to the hub 14, the welds are noted as item numbers 19.

The present invention provides a manner, different from that of welding, of securing the actuation wire and tines to the hub. In the present invention, the tines of the tissue approximating structure are crimped between an inner and outer wall of the hub.

FIG. 2 provides a perspective few of the hub 20 of the present invention in an uncrimped configuration. As shown, the hub 20 incorporates an exterior surface 22 and an interior surface 24. In the wall 26 existing between the exterior surface 22 and the interior surface 24, a plurality of bores 28 are spaced about the circumference of the hub 20. The bores 28 are preferably equidistantly spaced about the circumference and each is sized to accommodate the insertion of a tine (not shown). A cavity 29 is formed at the exterior surface of the hub 20 to accommodate passage of an actuation wire (not shown).

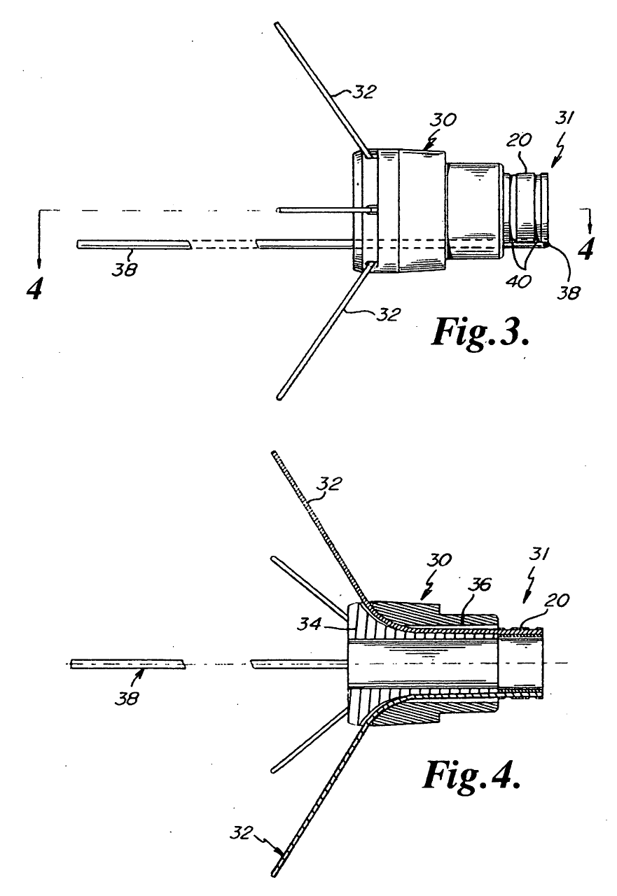

FIGS. 3 and 4 depict the deflector 30 and the hub 20 of a tissue approximating device 31. As shown, a plurality of tines 32 have been placed through the deflector 30, comprising an inner deflector 34 and an outer deflector 36, and the hub 20. An actuation wire 38 is placed within cavity 29. The hub 30 has been crimped (the crimp is noted with item number 40) with a crimping tool, preferably two times, to ensure retention of the tines 32. The pull strength of the crimp between the tines 32 and the hub 20 is preferably 4 lbs minimum. The crimping of the hub 20 to retain the tines 32 also operates to crimp the actuation wire 38 into the cavity 29. The pull strength of the crimp between the actuation wire 38 and the cavity 29 is preferably 8 lbs. minimum.

The above invention has been described with reference to anastomosis device for connecting urethral tissues. It should be noted that the present invention may also be used in other anastomosis applications with tissues other than urethral tissues.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A tissue approximating device, comprising:
a plurality of tissue engaging tines;
an actuator;
a deflector; and
a hub, wherein said plurality of tissue engaging tines extend through said deflector and into said hub, wherein said hub is crimped against said plurality of tissue engaging tines to permanently retain the tines within said hub, and wherein a first actuation of said actuator extends said plurality of tissue engaging tines outward from said deflector and wherein a second actuation of said actuator draws said plurality of tissue engaging tines back to said deflector.

2. The tissue approximating device of claim 1, wherein said actuator comprises an actuator wire and wherein said actuator wire is secured to said hub with the same crimp that retains said plurality of tissue engaging tines.

3. The tissue approximating device of claim 2, wherein said actuator wire is crimped to an external surface of said hub.

4. The tissue approximating device of claim 1, wherein said hub is crimped a plurality of times against said plurality of tissue engaging tines.

5. The tissue approximating device of claim 1, wherein the pull strength of the crimp between the plurality of tissue engaging tines and said hub is at least 4 lbs.

6. The tissue approximating device of claim 2, wherein the pull strength of the crimp between the actuation wire is at least 8 lbs.

7. A method for securing a plurality of tissue engaging tines of a tissue approximating structure, comprising the steps of:
inserting said plurality of tissue engaging tines through a deflector and into a hub; and
crimping an exterior surface of said hub to retain the position of said plurality of tissue engaging tines within said hub.

8. The method of claim 7, wherein said tissue approximating structure further comprises an actuator and wherein said method further comprising the step of crimping an exterior surface of said hub to retain said actuator against said exterior surface of said hub.

9. The method of claim 8, wherein the steps of crimping the tines and crimping the actuator are performed simultaneously through one crimping motion.

10. The method of claim 9, wherein said actuator comprises an actuator wire, wherein a first actuation of said actuator extends said plurality of tissue engaging tines outward from said deflector and wherein a second actuation of said actuator draws said plurality of tissue engaging tines back to said deflector.

11. The method of claim 9, wherein the steps of crimping the tines and crimping the actuator are performed a plurality of times.

12. The method of claim 7, wherein the step of crimping the tines provides a pull strength for the tines of at least 4 lbs.

13. The method of claim 10, wherein the step of crimping the actuator wire provides a pull strength for the actuator wire of at least 8 lbs.

14. A system for manufacturing a tissue approximating device, wherein said tissue approximating device includes the components of a plurality of tissue engaging tines, a deflector and a hub, the system comprising:
means for inserting said plurality of tissue engaging tines through said deflector and into said hub; and
means for crimping an external surface of said hub to retain said plurality of tissue engaging tines therein.

15. The system of claim 14, wherein said tissue approximating device further comprising an actuator and wherein said means for crimping also for crimping an external surface of said to maintain said actuator against an exterior surface of said hub.

16. The system of claim 15, wherein said actuator comprises an actuator wire and wherein a first actuation of said actuator extends said plurality of tissue engaging tines outward from said deflector and wherein a second actuation of said actuator draws said plurality of tissue engaging tines back to said deflector.

17. The system of claim 15, wherein said means for crimping simultaneously crimps said plurality of tissue engaging tines within said hub and said actuator against an exterior surface of said hub.

18. The system of claim 14, wherein said means for crimping establishes a pull strength of at least 4 lbs between said plurality of tissue engaging tines and said hub.

19. The system of claim 15, wherein said means for crimping establishes a pull strength of at least 8 lbs between said actuator and said hub.
